(19) United States
(12) Patent Application Publication
(10) Pub. No.: US 2004/0196354 A1
(43) Pub. Date: Oct. 7, 2004

(54) Laser marking/maging system

(76) Inventors: Steven K. Hansen, Port Washington, WI (US); Charles J. Check, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/815,593

(22) Filed: Apr. 1, 2004

Related U.S. Application Data
(60) Provisional application No. 60/459,795, filed on Apr. 2, 2003.

(51) Int. Cl. B41J 2/435

(52) U.S. Cl. 347/224

(57) ABSTRACT

A laser marking/imaging system including a passively Q-switched microlaser having a saturable absorber which upon reaching an energy threshold emits a pulse of light through an optical output. The microlaser is electrically connected to circuitry which provides power to the microlaser, and has a simmer mode and a lasing mode. In the simmer mode, power provided to the microlaser is maintained at an energy level below the energy threshold, and in the lasing mode, power provided to the microlaser raises the energy level of the microlaser above the energy threshold. A guidance mechanism can direct the pulse of light from the optical output along a path toward an image receiving target when the microlaser is in the lasing mode.

### CROSS REFERENCES TO RELATED APPLICATIONS

This application claims the benefit of provisional application Serial No. 60/459,795 filed Apr. 2, 2003, entitled “Laser Marking/Imaging System”, hereby incorporated by reference.

### STATEMENT REGARDING FEDERALLY SPONSORED RESEARCH

Not Applicable.

### BACKGROUND OF THE INVENTION

The field of invention is laser control systems, and more particularly a method of operating a microlaser having an absorbed power threshold, and particularly a passively Q-switched microlaser for use in a marking or imaging system.

High powered laser systems which produce high power pulses of light relatively quickly are typically expensive, large, and consume a great deal of power. Therefore, in applications such as laser printing, low power lasers are typically used. These lasers produce an insufficient amount of energy to create an image directly on print media, such as paper and, therefore, in order to form the image, the laser shoots a beam of light onto a photo sensitive drum to produce charged areas on the photo sensitive drum. Toner is attracted to the charged areas to produce an image on the drum. The toner is then transferred to the print media to form the image on the paper. Once the image is transferred to the paper, the paper passes through a fixing assembly which fuses the toner to the print media by squeezing and heating the toner.

The toner is typically a fine powder which can be brushed off of the print media to destroy the image prior to fusing to the print media. Moreover, the toner is typically contained in a toner cartridge which must be replaced or replenished for continued operation of the printer. Replacing or replenishing the toner cartridge can be messy, and result in disbursement of the powder into the atmosphere, onto an operator's hands, and onto the operator's clothing.

High power laser marking systems are known for directly marking an object using a laser beam. The laser beam is usually produced by a carbon dioxide, Nd:YAG, or Nd:YLF laser which burns an image into the object being marked. As noted above, these high powered lasers consume a tremendous amount of energy, and are extremely expensive.

A low powered passively Q-switched microlaser which produces high peak power pulses of light of extremely short duration disclosed in U.S. Pat. No. 5,394,413 can be used to directly mark objects and label media, and can also be applied in other medical and military applications. The Q-switched microlaser disclosed in U.S. Pat. No. 5,394,413 is a laser which includes a saturable absorber which blocks light below a specific absorbed power threshold, and emits energy above the threshold power level to escape the laser as short duration pulses. However, controlling and directing these high energy laser beam pulses to form images is very difficult. Furthermore, the time between laser pulse emissions is relatively long as compared, for example, to the imaging time provided by a laser toner system as described above. Accordingly, a need exists for improved methods and mechanism which can accurately and efficiently control high energy, short duration laser beam pulses for imaging purposes.

### BRIEF SUMMARY OF THE INVENTION

The present invention comprises a method for operating a microlaser having a saturable absorbed power threshold comprising the steps of applying power to the microlaser at a simmer level selected to maintain the laser below the absorbed power threshold, determining when a pulse is required, and increasing the power applied to the microlaser to a level above the absorbed power threshold, wherein the microlaser emits a pulse. By driving the microlaser at the simmer level, the time between a request for a pulse and the actual emission of a pulse from the microlaser is reduced, wherein the overall operational time can be decreased and efficiency of the laser system can be increased.

In another aspect of the invention, the present invention comprises a method for marking a target media using a microlaser having a saturable absorber which emits a high peak power pulse of light when the laser reaches a saturation level. An electrical current is applied to the microlaser to maintain it at a predetermined level below the saturation threshold, the predetermined level being selected to establish a short activation time of the microlaser. The microlaser is directed at a target media on which the image is to be made and, when appropriately positioned, the microlaser is activated by increasing the applied current above the maintenance level to quickly exceed the saturation level. The laser promptly emits a controlled pulse of high energy light for forming a mark on the target media. After the mark is formed, the current provided to the microlaser is decreased to the predetermined maintenance level from which it can again be activated with minimal turn on time to make another mark.

A general object of the invention is to precisely control a Q-switched microlaser for the purpose of forming marks on target media. By maintaining the Q-switched microlaser at an energy level just below its saturation level, the laser can be promptly and accurately fired to produce a mark with a small, controlled increase in applied current.

In another aspect of the invention, the microlaser is a passively Q-switched mircolaser provided in a laser marking/imaging system. The microlaser is electrically connected to control circuitry which maintains the microlaser in a “simmer state” below the saturation level when not producing a mark. The control circuit drives the microlaser to a “lasing state” by increasing the current level to the saturation level to emit a pulse of light when a mark is required. The system further includes a guidance mechanism which directs the high energy pulse of light along a path toward an image receiving target.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a block diagram of a laser marking/imaging apparatus incorporating the present invention;

FIG. 2 is a flow chart illustrating operation of the laser/marking imaging system of FIG. 1;

FIG. 2A is a pulse diagram illustrating the applications of power to a laser for each of a normal operation, low simmer operation, and a high simmer mode operation;

FIG. 3 is a block diagram of the circuitry of the apparatus of FIG. 1;

FIG. 4 is a partial view of the circuitry of FIG. 3, illustrating the laser drive circuitry of the laser marking/imaging system;

FIG. 4A is an alternate view of the laser drive circuit of FIG. 4;

FIG. 4B is a block diagram of a PID control loop employed in FIG. 4A;

FIG. 4C is a schematic illustrating the operation of the control loop of FIG. 4B;

FIG. 5 is a perspective view of the laser marking/imaging apparatus of FIG. 1;

FIG. 6 is a partially exploded perspective view of the apparatus of FIG. 5;

FIG. 7 is a cross-sectional view taken along the line 7-7 of FIG. 5;

FIG. 8 is a perspective view of the microlaser in the apparatus of FIG. 1;

FIG. 9 is a cross sectional view along line 9-9 of FIG. 8;

FIG. 10 is a cross sectional view along line 10-10 of FIG. 8;

FIG. 11 is a perspective view of the guidance assembly in the apparatus of FIG. 1;

FIG. 12 is a front elevation view of the guidance assembly of FIG. 11;

FIG. 13 is a perspective view of the media feed assembly in the apparatus of FIG. 5;

FIG. 14 is a top plan view of the media feed assembly of FIG. 11;

FIG. 15 is a perspective view of the media spool assembly in the apparatus of FIG. 5;

FIG. 16 is a front elevation view of the media spool assembly of FIG. 15;

FIG. 17 is a rear elevation view of the media spool assembly of FIG. 15;

FIG. 18 is a side elevation view of the media spool assembly of FIG. 15 with the wall mounting bracket removed;

FIG. 19 is a perspective view of an alternate laser marking/imaging apparatus incorporating the present invention;

FIG. 20 is a side view of the apparatus of FIG. 19;

FIG. 21 is a perspective view of another alternate laser marking/imaging apparatus incorporating the present invention;

FIG. 22 is a perspective view of yet another alternate laser marking/imaging apparatus incorporating the present invention; and

FIG. 23 is a flow chart illustrating the application of the simmer mode to a laser which can be applied in a number of various applications in order to decrease the time to activate the laser.

### DETAILED DESCRIPTION OF THE PREFERRED EMBODIMENTS

### System Overview

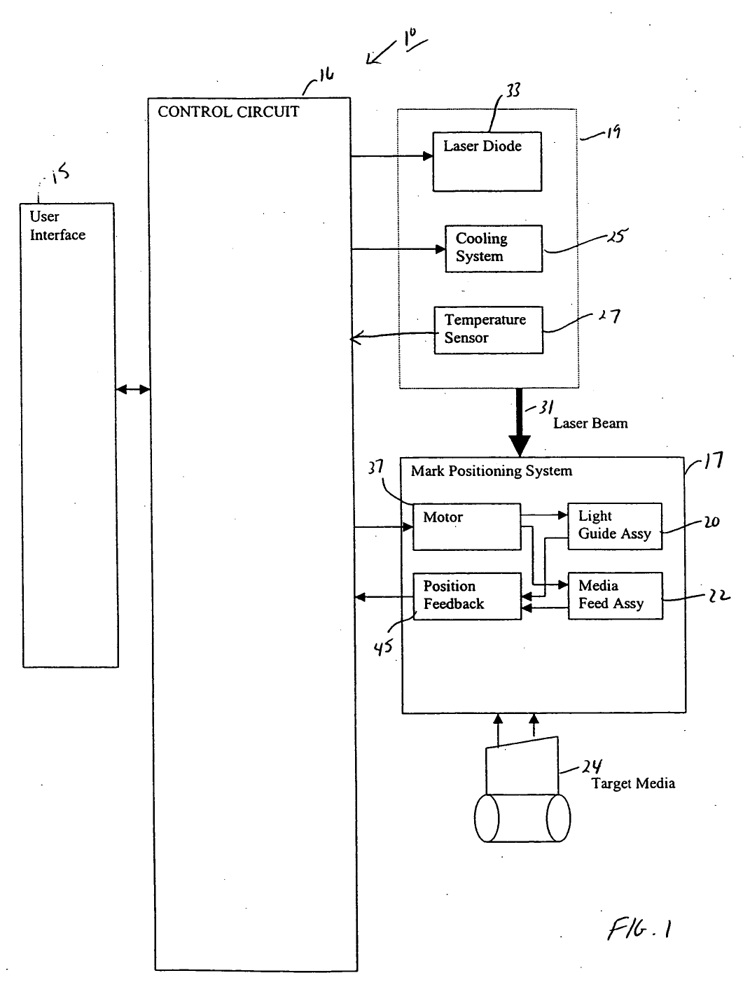

Referring now to the Figures and more particularly to FIG. 1, a block diagram of a laser marking/imaging system 10 constructed in accordance with the present invention is shown. The laser/marking imaging system 10 comprises a control circuit 16, user interface 15, a mark positioning system 17 and a laser system 19. A target media 24 on which a mark or image is to be made is fed into the mark positioning system 17 along with a laser beam 31 produced by the laser system 19. The control circuit 16 receives input signals from the user interface 15 indicating where the mark or image is to be made on the target media 24, and commands the mark positioning system 17 to position the target media 24 and/or the laser beam 31 to the selected location wherein the microlaser 33 is activated to provide the mark directly on the target media 24. When not marking the target media 24, the laser system 19 is maintained in a “simmer mode”. In the “simmer mode” power is applied to the microlaser 33 to maintain the microlaser 33 partially “on” but below the saturation threshold at which the absorbed power exceeds a threshold level to cause the microlaser 33 to emit a high energy light pulse. In this state, the turn-on time of the microlaser 33 is relatively fast such that a laser beam 31 can be turned on and off quickly and precisely to provide an efficient laser printing speed for the device, as described more fully below.

Referring still to FIG. 1, the laser system 19 comprises a microlaser 33, a cooling system 25 and related temperature sensor 27. The microlaser 33 is selected to provide high peak power pulses of light of extremely short duration such that a mark can be made directly on the target media 24. Preferably, a passively Q-switched laser, such as that described in U.S. Pat. No. 5,394,413 is employed. The passively Q-switched laser includes a “saturable absorber” which blocks the emission of high energy light pulses until a saturation power level is reached. The saturable absorber allows power to be applied while maintaining the microlaser 33 at a level below saturation. When the applied power is increased to drive the saturable absorber to the saturation level, the device enters the “lase” mode, in which high energy light is emitted. The saturable absorber can be maintained, for example, at a range of 50% to 90% of saturation, such that the additional amount of power required to activate the device is relatively low, and the turn on time to saturation is short. Although a passively Q-switched microlaser is preferred, other types of laser systems which produce high power pulses capable of directly marking a target media 24 and which can be turned on and off quickly to provide sufficient printing speed can also be used.

The cooling system 25 is provided to maintain the microlaser 33 within a selected temperature range, and preferably comprises a small, electronic device such as a thermoelectric cooler or TEC, which can be selectively activated to apply either heat or cooling to the microlaser 33. The temperature sensor 27 provides temperature feedback to the control circuit 16, and can comprise any of a number of sensors such as, for example, a thermistor.

In operation, the laser system 19 receives control signals from the control circuit 16 to drive the microlaser 33 and cooling system 25. The temperature sensor 27 provides temperature feedback to the control circuit 16, and the control circuit 16 monitors the temperature, voltage, and current levels of the microlaser 33 to maintain the microlaser 33 within a selected operating range.

Referring still to FIG. 1, the mark positioning system 17 comprises one or more motor or actuator 37 for driving a light guide assembly 20 and/or a media positioner assembly 22, as well as position sensors 45 for monitoring the location of each of the laser beam 31 and target media 24. The light guide assembly 20 can comprise, for example, one or more mirror and/or focusing lens for directing the laser beam 31 to a selected location and the media positioner assembly 22 can comprise, for example, a stepper motor for driving a roll of target media 24. In one typical setup described more fully below, the target media 24 is driven in an x-direction by a stepper motor while a mirror mounted to a gantry is driven in the y-direction. Using this system, any selected location in an x-y plane can be marked on the target media 24. The light guide assembly 20 and media positioning assembly 22, however, can include a number of various devices for driving and positioning the laser beam 31 and target media 24 as described in the specific embodiments below.

Referring still to FIG. 1, the user interface 15 comprises one or more user-interactive device such as a touch panel or keyboard for receiving input from a user, and a display screen for providing information to the user also as described more fully below. Electronic file input can also be provided using a PCMCIA, USB, Serial, or Ethernet connection. Input received from the user interface 15 provides data describing both the location and type of mark to be provided on the target media 24, which can be, for example, one or more alphanumeric character, or an entire two or three dimensional image to be provided on the target media 24.

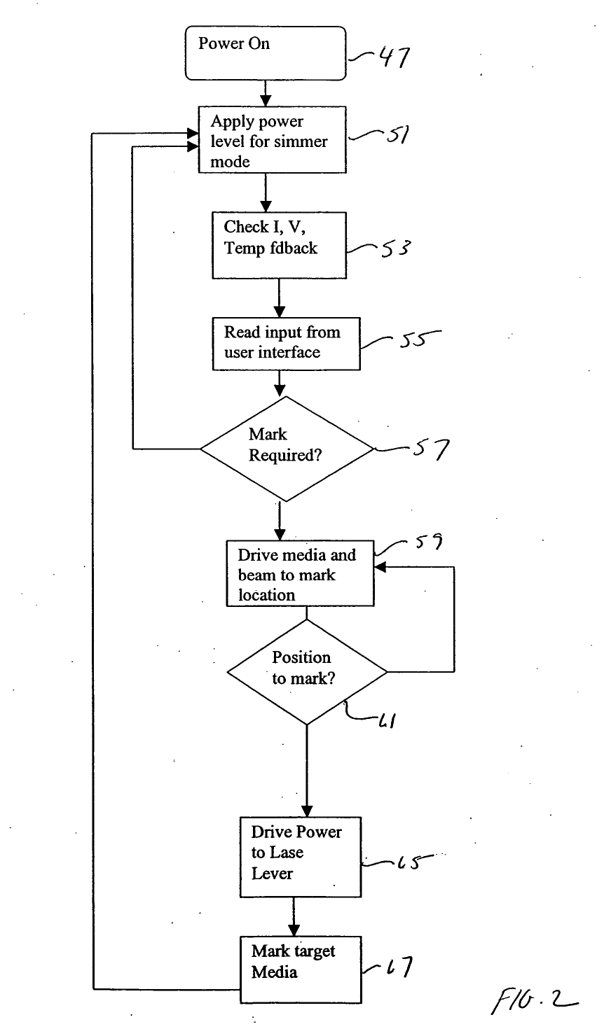

Referring now to FIG. 2, on power-up (step 47), the laser marking system 10 applies both a voltage and a current to the microlaser 33 (step 51), wherein the current is selected to maintain the power applied to the microlaser 33 at a level below the saturation threshold and therefore in the “simmer mode”. The marking system 10 then begins to monitor both the temperature, voltage, and current feedback from the microlaser 33 in order to maintain the temperature, current and voltage in a predetermined range of operation (step 53). As noted above, in the “simmer mode”, the power applied to the microlaser 33 is selected to maintain the microlaser 33 in an “active” state below actual “lasing”. By maintaining the microlaser 33 in the simmer mode, the turn-on time for the microlaser 33 is significantly reduced, allowing the microlaser 33 to be activated quickly when a mark is required, thereby providing a fast and efficient laser printing or marking speed, as described below.

Referring also to FIG. 1, after the “simmer mode” is established, the control circuit 16 reads input from the user interface 15 to determine whether instructions to provide a mark or image on the target media 24 have been received. If so, the control circuit 16 commands the mark positioning system 17 to drive the target media 24 and the laser beam 31 toward the selected location (step 59) until properly positioned (step 61). The power applied to the microlaser 33 is then increased to increase the amount of power absorbed by the microlaser 33 above the saturation threshold into the “lase” level (step 65). When the microlaser 33 is driven above the saturation threshold, the microlaser 33 emits a high intensity pulse of light which causes a mark to be made on the target media 24 (step 67). The size of the mark is controlled by the number of pulses emitted and the energy level at the mark location. After the mark is complete, the control circuit 16 returns the microlaser 33 to the simmer mode. If another mark is requested, the control circuit 16 again commands the mark positioning system 17 to drive the target media 24 and laser beam 31 positioning components to the required location, and repeats the steps above.

Referring now to FIG. 2A, a pulse diagram illustrating the application of power to the microlaser 33 as described above, and the resultant optical pulse output versus time for each of a “normal”, “low simmer”, and “high simmer” situation, as derived experimentally, is shown. In each case, a voltage of 1.85V is applied to the microlaser 33. For normal operation, a current of 1.5 A is applied to increase the amount of power absorbed by the microlaser 33 above the saturation threshold. Here, the repetition rate for the Q-switched diode is 5 Khz, and a pulse is emitted 200 microseconds after the saturation threshold is met, as determined by the switching repetition rate of the selected microlaser 33.

In the low simmer example, a current of 0.75 A, half of the required current to drive the saturable absorber above the threshold power level, is applied. The optical pulse is not emitted until the current is driven to the 1.5 A level described above, thereby exceeding the saturation threshold. Because of the applied simmer current, however, the time between application of the 1.5 A current and emission of a pulse is reduced to 150 microseconds, as opposed to the 200 microseconds described above.

In the high simmer example, a current of about 90% of the current required to increase the absorbed power of the saturable absorber above the threshold saturation level is applied. Here, because of the high simmer current, an optical output pulse is emitted only 5 microseconds after the current is raised to the 1.5 A level required to exceed the saturation threshold.

Although the simmer mode is described to include a constant applied voltage and varying current, the current could be held steady and the voltage varied to drive the power absorbed by the microlaser 33 above the saturation threshold. Alternatively, both the applied voltage and current could be varied, such that total absorbed power is held below the saturation threshold during simmer, and raised to or above the saturation threshold when optical output is desired. Furthermore, the pulse diagram of FIG. 2A is shown as power is first applied to the microlaser 33. During actual operation, the amount of absorbed power in the microlaser 33 may vary, resulting in variations in the timing shown.

To maintain the device within the appropriate operating range, the current and voltage feedback is monitored to maintain the power absorbed by the device below the saturation threshold when optical output is not desired, and above the saturation threshold when optical output is desired. As the switching of the microlaser 33 tends to heat the microlaser package 18, temperature is monitored and the cooling system 25 is activated or de-activated to maintain the microlaser package 18 in a temperature range between twenty and twenty-seven degrees Celsius, shown experimentally to be an appropriate temperature range for maintaining control over the microlaser 33.

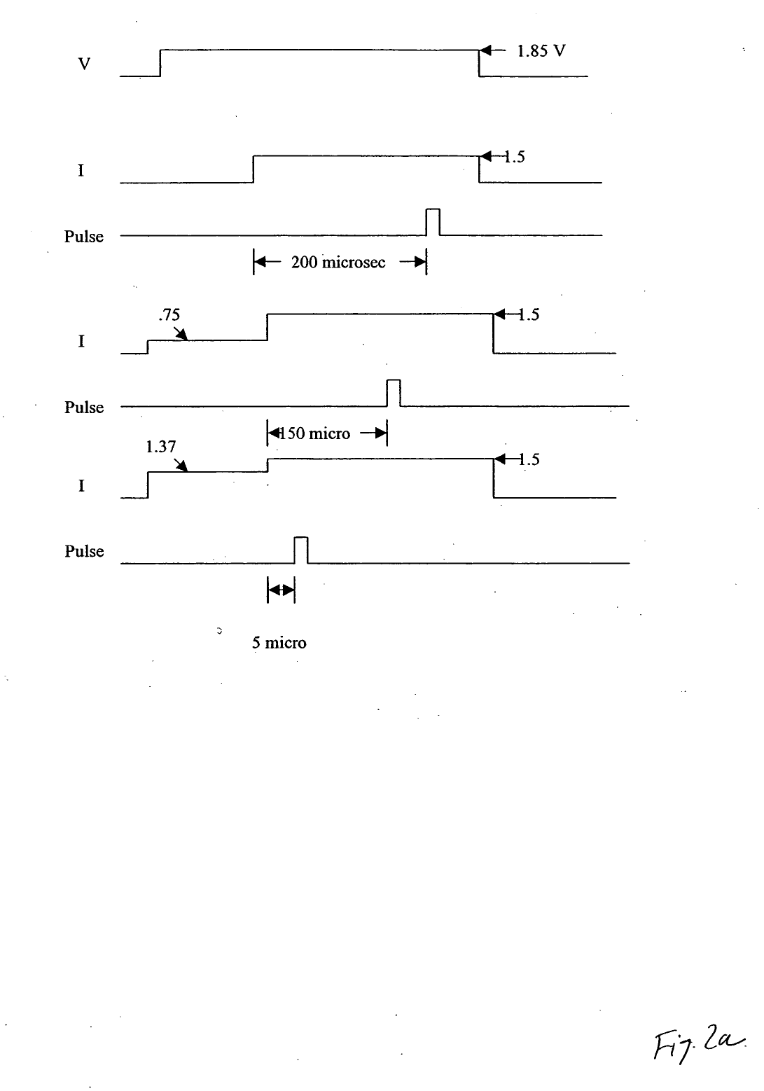

Although there are a number of possible control circuit 16, laser system 19, and mark positioning system 17 configurations, one embodiment is shown in FIG. 3. Here, the control circuit 16 includes circuitry for controlling a number of different motors or activators which can optionally be used in various mark positioning systems 17 for positioning various types of media. The circuit 16 can therefore be used in a “modular” system, wherein a single circuit can be used to drive a number of different laser marking/imaging system 10 configurations for use with various media types.

The control circuit 16 comprises a user interface circuit 54 and a laser control circuit 56, each of which includes a separate controller 62 and 80 and associated circuitry, respectively. The interface circuit 54 is electrically connected to the control circuit 56 by a high speed serial interface 58 and a parallel interface 60 to facilitate data exchange therebetween.

The user interface circuitry 54 includes a 32 bit RISC controller 62 controlled by an operating system, such as a Windows CE front-end. The controller 62 is connectable to a plurality of user input devices, such as a standard QWERTY keyboard 66 and a touch panel 42, and further includes electrical interfaces including one or more universal serial bins (USB) ports 70, serial ports 72, and parallel ports 74, as well as a PCMCIA (personal computer memory card intimate and association) slot 76, all of which can be used to receive digital image data and files from electronic devices, such as a host computer. The user interface circuit 54 further includes sufficient memory, such as 32 Mb synchronous dynamic random access memory (SDRAM) and 32 Mb of flash readable memory (ROM) for storing data entered by the user. The controller 62 is further coupled to a display device, such as a liquid crystal display (LCD) 64, which can provide operational data to the user.

Referring now also to FIG. 1, the control circuitry 56 includes a 16 bit controller 80 and associated circuitry for controlling the laser system 19 and various parts of the mark positioning system 17, a motor control circuit 13 which drives various motors and actuators in the mark positioning system 17, and a galvo control device 97 for driving a galvo mirror system 99. The mark positioning system 17 can be configured to include one or more of a media feed stepper motor 96 for driving a roll of media, a focus stepper motor 91 for driving a focus lens for controlling the direction and focus of the laser beam 31; and a DC motor 92 for driving a gantry which can include, for example, a mirror for directing the laser beam 31; and the galvo mirror system 99, also for directing the laser beam 31. The mark positioning system 17 further includes a plurality of position sensors including a linear or quad encoder 82 providing position feedback from, for example, a gantry system, a focus “home” sensor 85, providing a home position for a focus lens; an “X-Y home” sensor providing a home sensor for use with, for example, an x-y positioner or table; and a “gantry home” sensor 86, providing a home position for a gantry. The mark positioning system 17 may also include a “cutter” motor 93 activated to cut a marked or imaged portion of target media 24 from a sheet or roll, and an end of media sensor 83, which provides an indication when a roll or sheet of target media 24 is nearing the end. The control circuit 16 is powered by a power supply 68, and includes a disable switch 63 which cuts the power to the control circuitry 56 including the microlaser 33. The use of the various components of the mark positioning system 17 to provide a light guide assembly 20 (FIG. 1) and/or a media positioner assembly 22 (FIG. 1) will be described with reference to specific embodiments, below. Although a number of galvo control devices are available, one device which can be used is a MiniSAX provided by GSI Lumonics Component Products Group of Billerica, Mass. which comprises a servo driver for controlling the galvo mirror system 99.

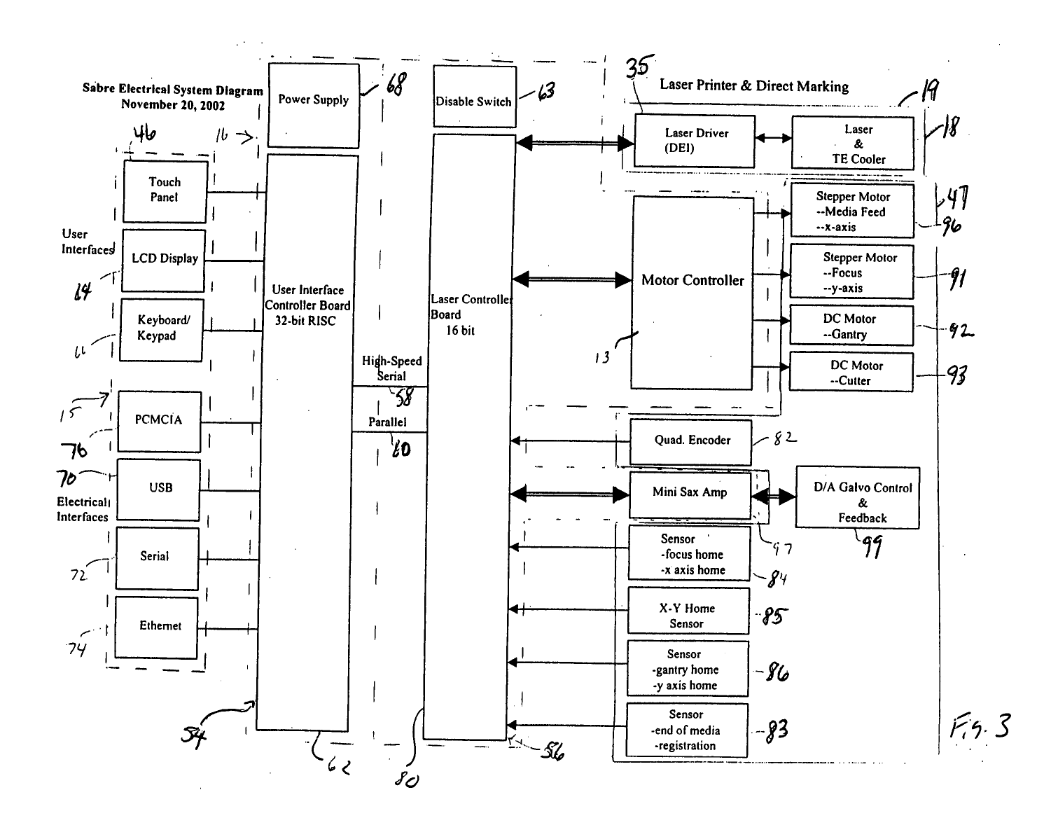

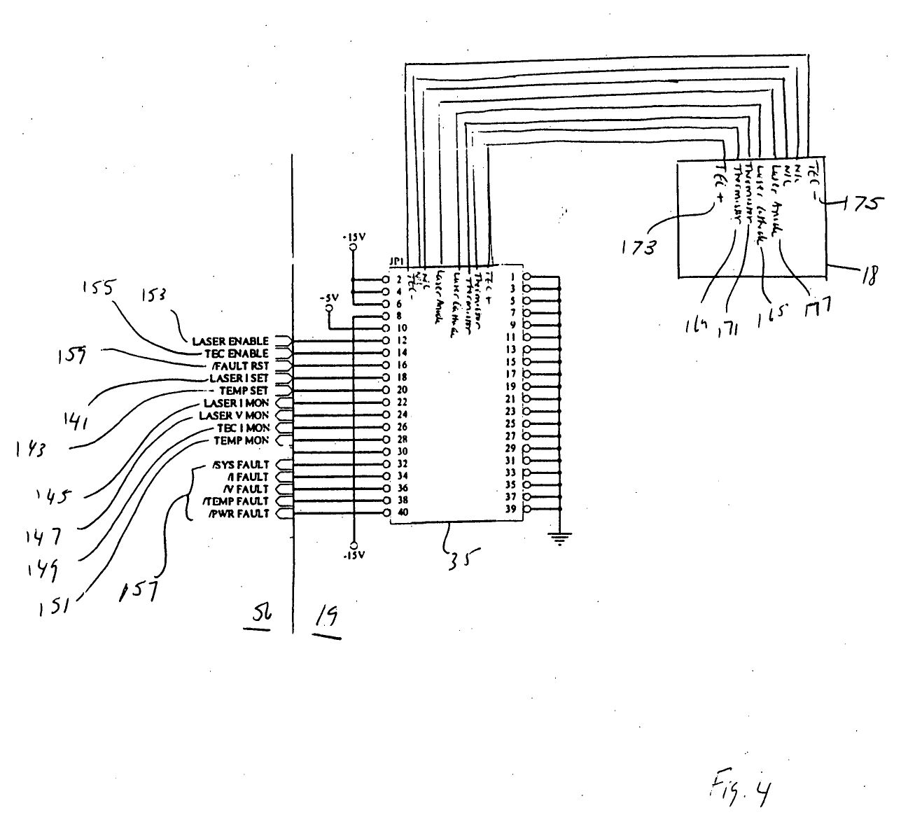

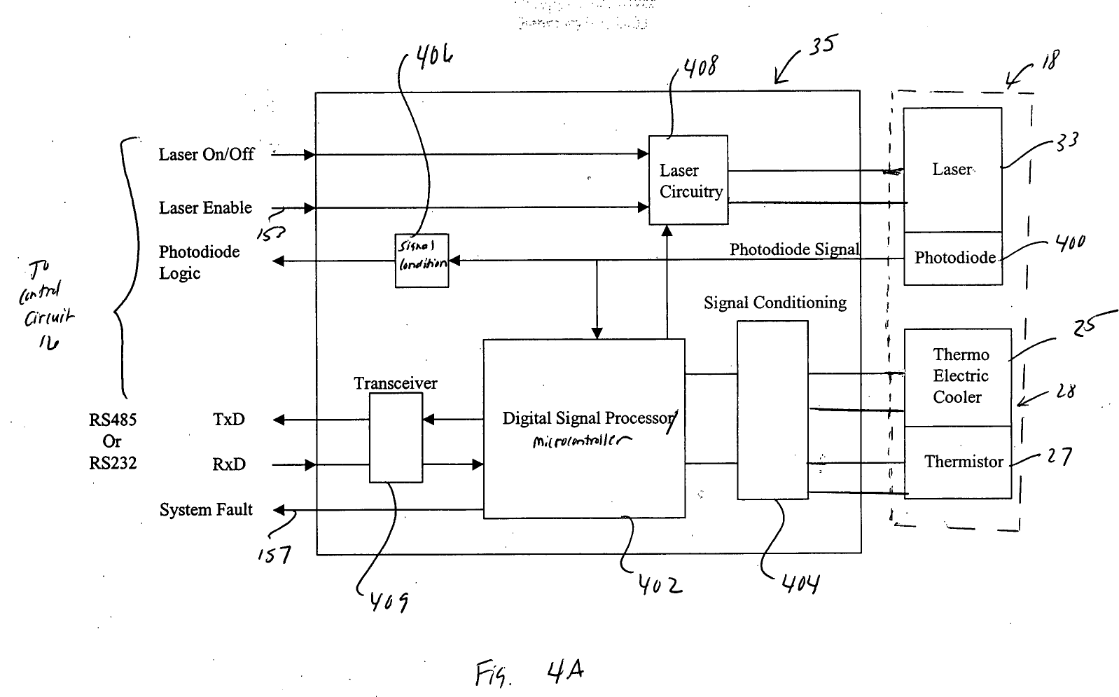

Referring now to FIG. 4, the connection of the laser system 19 to the controller 80 (FIG. 3) is shown in detail. Here, the laser system 19 includes a device driver 35 and microlaser package 18. The microlaser package 18 shown in FIG. 4 includes the microlaser 33, cooling system 25, and temperature sensor 27, as described above with reference to FIG. 1, in a single microlaser package or chip 18 (FIG. 3), preferably comprising a TO-3 package, such as described in U.S. Pat. No. 6,072,815 which is fully incorporated herein by reference. As noted above, the microlaser 33 is a passively Q-switched microlaser having a gain medium coupled to a saturable absorber, such as disclosed in U.S. Pat. No. 5,394,413 which is fully incorporated herein by reference. The microlaser package 18 also includes cooling system 25 which is an on-board thermoelectric cooler (TEC) device, and a temperature sensor 27 which is an on-board thermistor. Although a microlaser package 18 which includes a microlaser 33, cooling system 28, and temperature sensor 27 is shown, microlasers not enclosed in a microlaser package can be used without departing from the scope of the invention.

The device driver 35 is preferably a PCO-6510 laser diode driver module commercially available from Direct Energy, Inc. of Fort Collins, Colo. The device driver 35 includes a current source for driving the microlaser 33 which is capable of delivering currents from 0 to 5 A with forward voltages up to 5V, and can support waveforms that vary from DC to 20 kHz bandwidths. Additionally the device driver 35 is equipped with a thermoelectric cooler (TEC) controller, capable of delivering up to 3 amps at 3.5V for heating or cooling of the microlaser 33. The device driver 35 further includes control circuitry for enabling and disabling both the diode current source and the TEC current source. The device driver 35 further includes circuitry for providing feedback from the microlaser 33, including a microlaser Current monitor, microlaser Voltage monitor, TEC temperature monitor, and a TEC current monitor. To protect the microlaser from damage, the device driver also includes four types of fault protection: microlaser over current, microlaser over voltage, over temperature faults and power supply undervoltage faults. The fault protection circuitry ensures that the device driver 35 will not exceed limitations of the microlaser 33. In the event any of the faults occur they latch off the diode current source, but allow the TEC to keep regulating the diode temperature. A Reset Fault control line is provided to reset the device after fault conditions are detected.

The laser control circuit 56 supplies a laser current control signal 141 and a temperature set signal 143 to the device driver 35 to establish operational and temperature conditions. As noted above, in the “simmer mode”, the current control signal 141 is selected to maintain the microlaser 33 at an operational level below the lase state, but partially active such that the turn on and turn off times of the microlaser 33 are fast, allowing for substantial control of the size of the mark produced and a fast printing speed, wherein a number of marks can be provided in a short period of time. To assure proper operation, the control circuit 56 monitors a laser current signal 145, laser voltage signal 147, TEC monitor signal 149, and temperature monitor signal 151. To enable the microlaser 33 and cooling system 25, the control circuit 56 further provides a laser enable signal 153 and TEC enable signal 155 to the device driver 35. The fault signals 157 described above are also monitored and, in the event of a fault condition, the control circuit 56 provides a reset signal 159 to the device driver 35. As described above, the control circuit 16 maintains the microlaser 33 in a “simmer mode” until a mark is requested, and then increases the current control signal 141 to a “lase” level and provides a laser enable signal 153 to the device driver 35.

Based on input commands from the laser control circuit 56 as described above, the device driver 35 provides TEC plus and minus control signals 173 and 175, and laser anode 165 and cathode 167 controls to the microlaser package 18. The device driver 35 further reads feedback from the temperature sensor 27 (FIG. 1) on temperature sensor feedback lines 169 and 171. Control circuitry in the device driver 35 maintains the microlaser 33 within the requested operational parameters. The control circuit 16 controls the mode of the microlaser 33 by selectively activating the laser enable input and controlling the current command to the microlaser 33, in accordance with the method described above and with reference to FIG. 2.

Referring now to FIG. 4A, a second embodiment of a laser device driver 35 and microlaser package 18 is shown. Here, the microlaser package 18 includes a microlaser 33, an optional photodiode 400, a cooling system 25 (preferably a TEC, as described above, which provides both heating and cooling functions), and a temperature sensor 27. The microlaser device driver 35 includes a local microprocessor or digital signal processor 402 for controlling the microlaser 33 and cooling system 25, a first signal conditioning circuit 404 for amplifying and isolating signals transmitted between both the cooling system 25 and thermistor 27 and the local microprocessor 402, a second signal conditioning circuit 406 for receiving a signal from the photodiode 400 and amplifying the signal to a level which is compatible with both the local microprocessor 402 and the control circuit 16 (FIG. 1), and a laser switching circuit 408 for driving the microlaser 33 on and off. The laser switching circuit 408 includes a semiconductor switching device such as a MOSFET or IGBT which is enabled upon receipt of the laser on/off signal and laser enable signals from the control circuit 16 (FIG. 1), and is switched on and off by the local microprocessor 402 which controls the microlaser 33 using a control loop such as a pulse width modulation algorithm. The microcontroller 402 further controls the cooling system 25 using a PID (Proportional, Integral, Derivative) Loop. The PID loop (FIG. 4B) maintains the temperature of the microlaser 33 within a pre-determined range of a set point by monitoring feedback from the thermistor 27, and controlling the cooling system 25 to maintain the microlaser 33 within the expected temperature range. The PID loop calculates the difference (error) between the temperature at the thermistor 27 and an expected temperature provided by the control circuit 16 through, for example, a serial link through transceiver 409, and adjusts the output to the cooling system 25 to drive the temperature of the microlaser 33 to the selected temperature, minimizing the error, as described below.

Referring now also to FIG. 4B, a block diagram of a PID loop as provided in the microcontroller 402 is shown. As is known in the art, the proportional, integral, and derivative constants in the PID loop are used to calculate an output as a function of an error between a set point and an actual temperature. Here, the output is provided to the cooling system 25 to drive the TEC, and is based on a difference between a selected temperature for operation of the microlaser 33 and the actual temperature as determined from feedback from the thermistor 27. In the PID loop, a set point temperature 411 is provided as input. This set point temperature 411 is determined experimentally for a specific microlaser 33, as described below, and can be, as shown, a temperature of 30 degrees C. The input set point temperature 411 is compared to feedback of the actual temperature determined at the thermistor 27 at the block 410. The PID loop includes a proportional gain 412, an integral term 414, and a derivative term 416, which have been assigned the gain values of 30, 10/0.1 s, and 5, respectively, as shown in FIG. 4B. At block 418 the output of the PID variables are summed, and are provided to a heat sink transfer function 420, which provides an estimation of the expected change based on a heat sink associated with the microlaser 33 and any other cooling elements outside of the TEC, and which here is modeled as having both a resistive and a capacitive component. The output of the PID loop 424 (FIG. 4C) is fed to the TEC which, as described above, can be selectively driven to cool or heat the microlaser 33.

It has been determined experimentally that, to provide the best printing characteristics, the microlaser 33 is to be driven at a repetition rate between five and seven kilohertz, at an energy level of about sixteen microjoules. Under these operating conditions, an operational temperature of twenty-two degrees C. is typically required to maintain the microlaser 33 within the required operational range for the specific microlaser described above. To maintain consistent printing characteristics, the temperature of the microlaser 33 should be maintained at the selected temperature within a range of plus or minus 0.25 degrees C. As described above, these parameters, and the associated gains in the PID, were determined for the specific Q-switched microlaser 33 described in U.S. Pat. No. 5,394,413, but can vary depending on both the type of microlaser used and the individual microlaser. For proper printing operation, each microlaser 33 must be evaluated and individually calibrated to determine the optimal operating temperature at the optimal energy level and repetition rate. The selected operational temperature for each microlaser 33 is therefore preferably determined in a test procedure and is then stored in the control circuit 16 (FIG. 1), and can be revised as necessary during use, along with the PID gains and other parameters.

Referring now to FIG. 4C, a sample output of the PID loop of FIG. 4B is shown. Here, the temperature set point 411 is initially set at zero degrees C., and is then changed to thirty degrees C. The temperature 422 of the microlaser 33 climbs to a level of about thirty degrees C., then above thirty degrees C., and is stabilized by the PID loop at approximately the thirty degree C. mark. The output 424 for driving the cooling system 25 initially increases to drive the temperature up causing the temperature of the microlaser 33 to rise, and then stabilizes the temperature of the microlaser 33. While the sample is shown for a thirty degree C. set point, as described above, the selected temperature level will vary depending on the type of microlaser 33 used, and will also vary from individual microlaser 33 to individual microlaser 33. These parameters, therefore, must be independently determined for each microlaser 33.

Although the microlaser 33 can be controlled based on operational temperature as described, in alternate embodiments a photodiode 400 can be provided in conjunction with the microlaser 33 and used to control the microlaser output. The photodiode 400 is actuated with the microlaser 33, and the output of the photodiode 400 can be monitored by the microcontroller 402 to monitor the microlaser 33 to determine whether it is operated within the expected repetition rate.

Referring now to FIGS. 1 and 5-9, the laser marking/imaging system 10 is provided in a housing including an electronic enclosure 12 and a printing enclosure 14. The electronic enclosure 12 houses control circuit 16 for controlling the system 10 and the laser system 19. The laser beam 31 generated by microlaser package 18 passes from the electronic enclosure 12 into the printing enclosure 14, which houses the mark positioning system 17 including a light guidance assembly 20 and a media feed assembly 22. The light guidance assembly 20 selectively directs the light pulses produced by the microlaser 33 toward an image receiving target media 24 fed past the light guidance assembly 20 by the media feed assembly 22 to form an image on the target media 24. As noted above, the heat generating components, including the control circuit 16 and microlaser package 18, are provided in the electronic enclosure 12, separated from the rest of the system to facilitate heat management of the system. The mark positioning system 17 is maintained in a separate printing enclosure 14, which can be removed and replaced, thereby providing a “modular” laser marking/imaging system 10 which can be adapted for use with various types and configurations of target media 24 as discussed above.

The image receiving target media 24 can be any media, such as paper, plastic, wood, metal, and the like, which can be marked by high energy pulses of light. Preferably, the image receiving target media 24 is labeling media 26 provided in the form of a roll which is fed by the media feed assembly 22 into the path of the high energy light pulses generated by the microlaser package 18 to form an image. Although an image receiving target media 24 which can be fed by the media feed assembly 22 is preferred, image receiving targets, such as IC chips, diamonds, machine parts, electronic components, and the like which can be manually or automatically positioned in the path of the light pulses, can be used without departing from the scope of the invention.

As noted above, the electronic enclosure 12 encloses the circuitry 16 and microlaser package 18. The enclosure 12 includes a horizontal base 30 which supports opposing left and right side walls 32, 34 joined by a rear wall 36 and a cover 38. A window 40 formed in the cover 38 frames the touch panel 42 electrically connected to the circuitry 16. A cooling fan 44 can be fixed to one of the walls 32, 34, 36 inside the electronic enclosure 12 to circulate cooling air through the electronic enclosure 12 and out of a vent 46 formed in the electronic enclosure rear wall 36. Preferably, the circuitry 16 is formed at least in part on a printed circuit board 50 having an edge 52 fixed to the rear wall 36 and spaced from the sidewalls 32, 34 to allow air currents generated by the cooling fan 44 to circulate through the electronic enclosure 12 and cool the microlaser package 18 and circuitry 16.

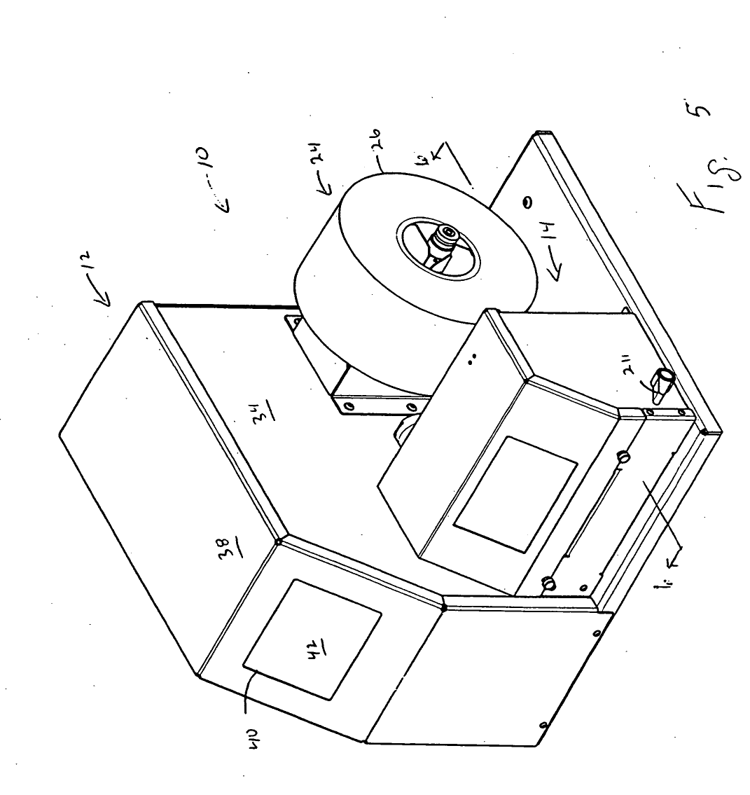

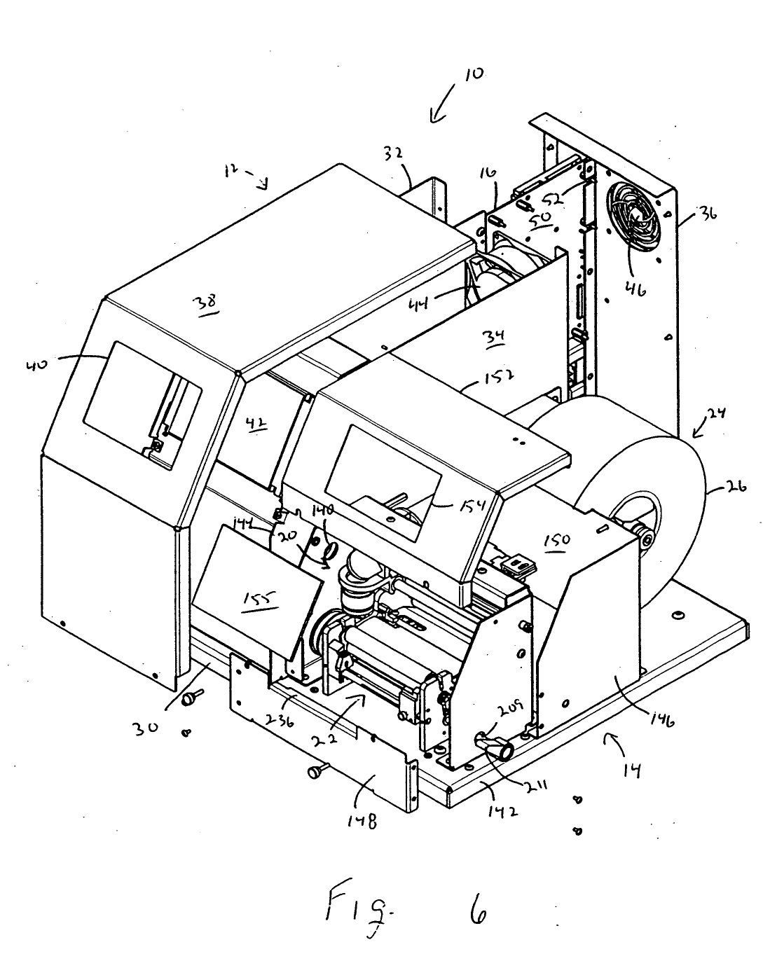

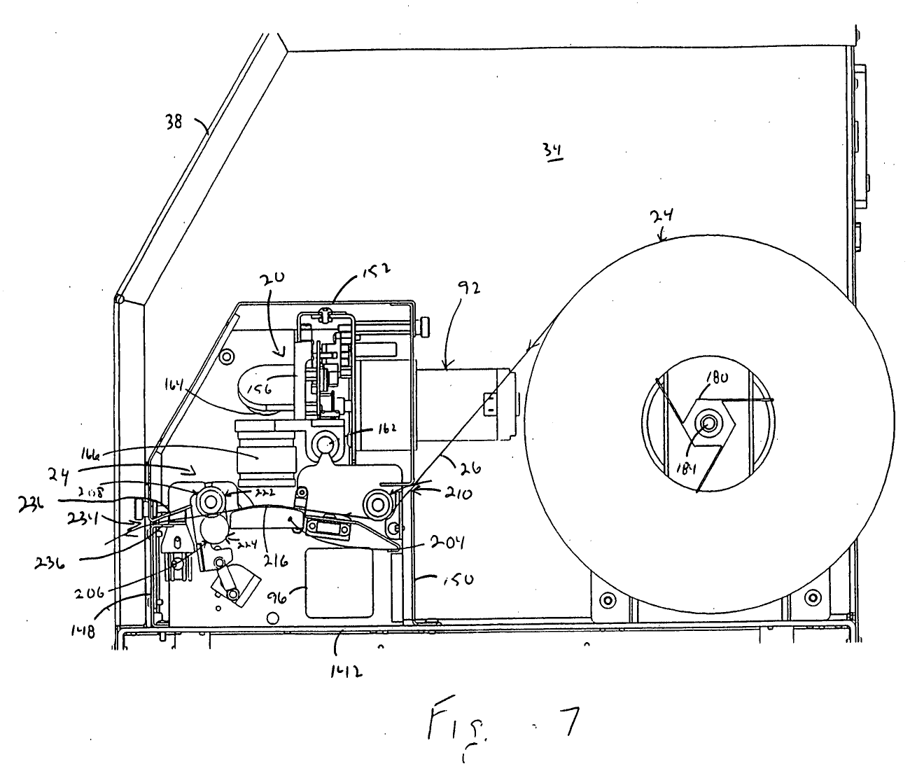

As shown in FIGS. 8-10 and 19-21, microlaser package 18 is provided in a collimator assembly 100 in the electronic enclosure 12 (FIG. 5), the collimator assembly 100 including components for focusing and directing the light pulses produced by the microlaser 33 to provide the controlled laser beam 31 of FIG. 1 for marking the target media 24. Referring now to FIGS. 9 and 10, the microlaser package 18 is mounted at a first, input end 126 of the collimator assembly 100, and light is directed from the microlaser 33 in the microlaser package 18 to a first lens 112 located in a lens assembly 116 at the approximate center of the collimator assembly 100 and from this to a second lens 136 at the opposing end 128 of the collimator assembly 100.

Referring still to FIGS. 9 and 10, the microlaser package 18 is mounted to a printed circuit board 110 coupled to the input end 126 of a housing 120 of the collimator assembly 100, with the microlaser 33 directed into the housing 120 along a longitudinal optical axis 124 toward the lens 112. A heat sink 134 is provided to maintain the microlaser package 18 within the selected operating temperature, in conjunction with the operation of the TEC cooling system 25 (FIG. 1) described above.

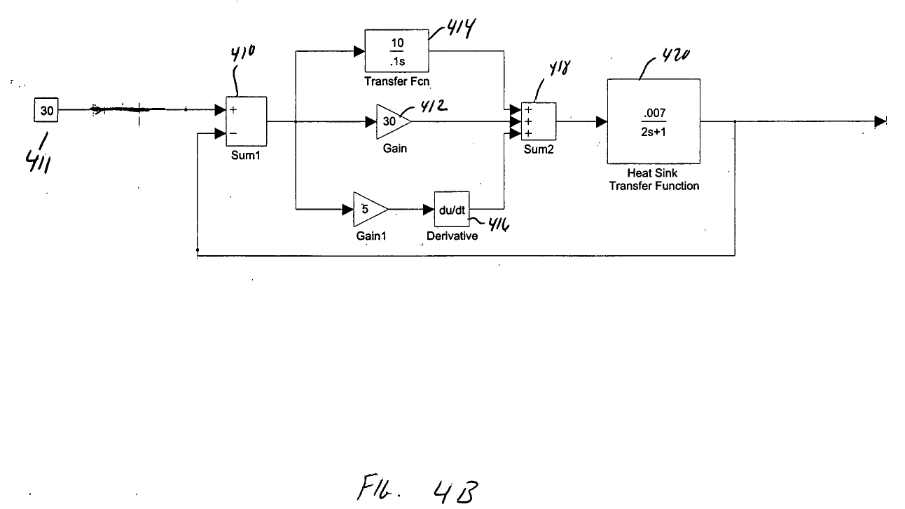

The light produced by the microlaser 33 is directed to the lens assembly 116 and through an optical input 106 to the lens 112. The light is then directed through an optical output 108, and toward the convex lens 136, which is mounted to a bracket 138 at the opposing, output end 128 of the collimator assembly 100. The lens 112 expands or enlarges the beam of light emitted by the microlaser package 18, and the lens 136 collimates the expanded beam for application in making a mark on the target media 24 (FIG. 6). The collimated light is focused by either a galvo system or bend as described below.

As shown in FIG. 6, the output from the collimator assembly 100 (FIG. 8) is directed through an opening 140 formed through the right side wall 34 of the electronic enclosure 12 into the printing enclosure 14 where the light guidance assembly 20 and the media feed assembly 22 of the mark positioning system 17 direct the laser beam 31 (FIG. 1) to the appropriate location on the target media 24. As shown, the printing enclosure 14 includes a base 142, a left side wall 144, and a right side wall 146, joined by a front wall 148, a rear wall 150, and a cover 152. Preferably, the left side wall 144 of the printing enclosure 14 and the right side wall 34 of the electronic enclosure 12 is a common wall. Likewise, preferably, the printing enclosure base 142 and electronic enclosure base 30 are formed as a single piece. A rectangular opening 154 formed in the cover 152 frames a tinted transparent material 155, such as glass, plastic, and the like, that allows a user to view the inside of the printing enclosure 14.

As noted above, the laser marking system 10 is constructed to include circuitry 16 capable of controlling a number of different mark positioning systems 17. Variations of mark positioning systems 17 are provided in the specific embodiments below, wherein variations in the components provided in the printing enclosure 14 are shown and described.

### First Embodiment

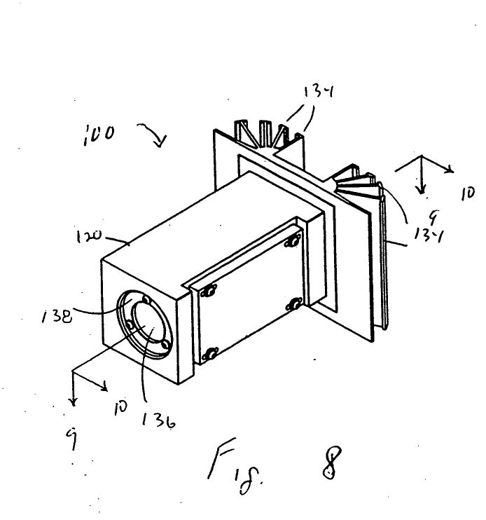

Referring to FIGS. 1, 5, 7, 11, and 12, a first embodiment of a mark positioning system 17 housed in printing enclosure 14 as shown. Here, the light guidance assembly 20 comprises a mirror 164 mounted to a gantry 158 driven by a DC motor 92 and the media positioning assembly 22 comprises a stepper motor 96 for driving a roll 26 of target media 24. As described above, the light guidance assembly 20 selectively directs the light pulses toward the image receiving target media 24 to form an image on the target media 24, and includes a carriage 156 slidably mounted to the gantry 158 supported by end frames 160 fixed to the printer enclosure base 142. The gantry 158 is mounted above the image receiving target media 24 transverse to the direction of travel of the image receiving target media 24, and includes a transverse rod 162 extending between the end frames 160. The rod 162 slidably supports the carriage 156 above the image receiving target media 24. Of course, additional supports 163 can be provided to slidably support the carriage 156 between the end frames 160. Advantageously, the transversely mounted gantry 158 provide a carriage travel path transverse to the direction of travel of the image receiving target media 24 which in cooperation with the movement of the image receiving target media 24 provides the ability to form two dimensional images on the target media 24.

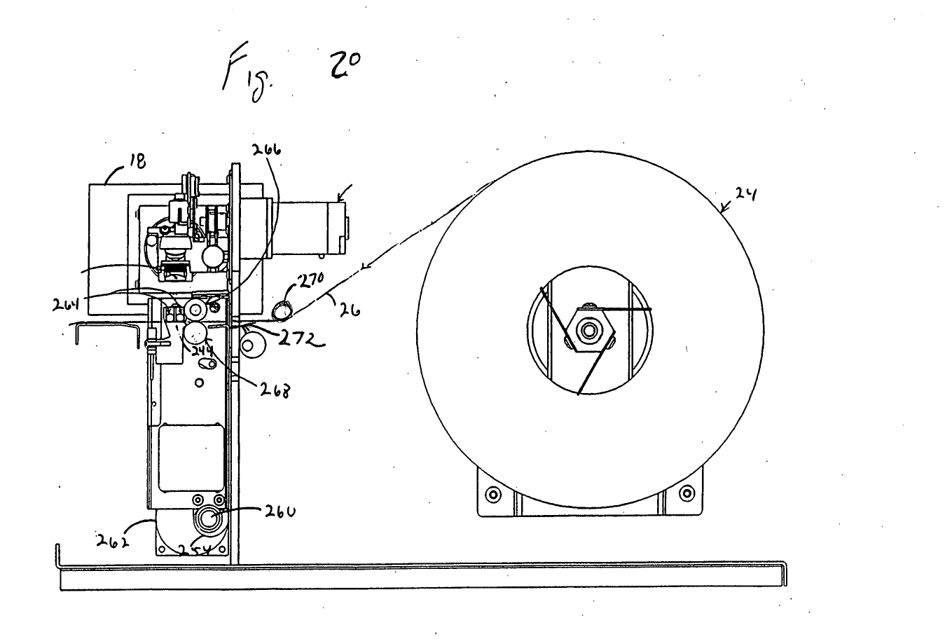

The carriage 156 carries a mirror 164 and a focusing lens 166 which direct and focus the light pulses onto the image receiving target media 24, and is driven by a synchronous belt 168 using a DC brushed motor 92. The belt 168 has opposing ends fixed to the carriage 156, and wraps around pulleys 172, 174 mounted proximal each end frame 160. One of the pulleys 172 is rotatably driven by the motor 92 to drive the carriage 156 transverse to the direction of travel of the image receiving target media 24. A carriage spring return 167 (shown more clearly in the embodiment disclosed in FIG. 19) having one end fixed to the carriage 156 and an opposing end fixed to the gantry 158 biases the carriage 156 toward a home position adjacent the microlaser package 18 and dampens sudden movements of the carriage 156.

The mirror 164 carried by the carriage 156 is oriented at an angle of approximately 45° relative to the direction of travel of the light pulses emitted from the microlaser 33, and redirects the light pulses through the focusing lens 166. The focusing lens 166 focuses each light pulse to create a dot on the image receiving target media 24. Focusing the light pulse on the image receiving target media 24, such that the distance between the focusing lens 166 and the image receiving target media 24 is equal to the focal point of the lens 166 forms a small dot on the target media 24. Changing the distance between the focusing lens 166 and the image receiving target media 24, such that the light pulse is not focused on the target media 24, changes the size of the dot.

The specific focusing lens 166 necessary to focus the light depends on the distance between the focusing lens 166 and the image receiving target media 24 and the desired dot size. A fixed distance between the focusing lens 166 having a fixed focal length and the image receiving target media 24 provides a fixed dot size. Preferably, however, the distance between the focusing lens 166 and image receiving target is adjustable, such as by providing an adjustable focus lens and/or height adjustable support platform which supports the image receiving target media 24 in the light pulse path to form a multitude of dot sizes.

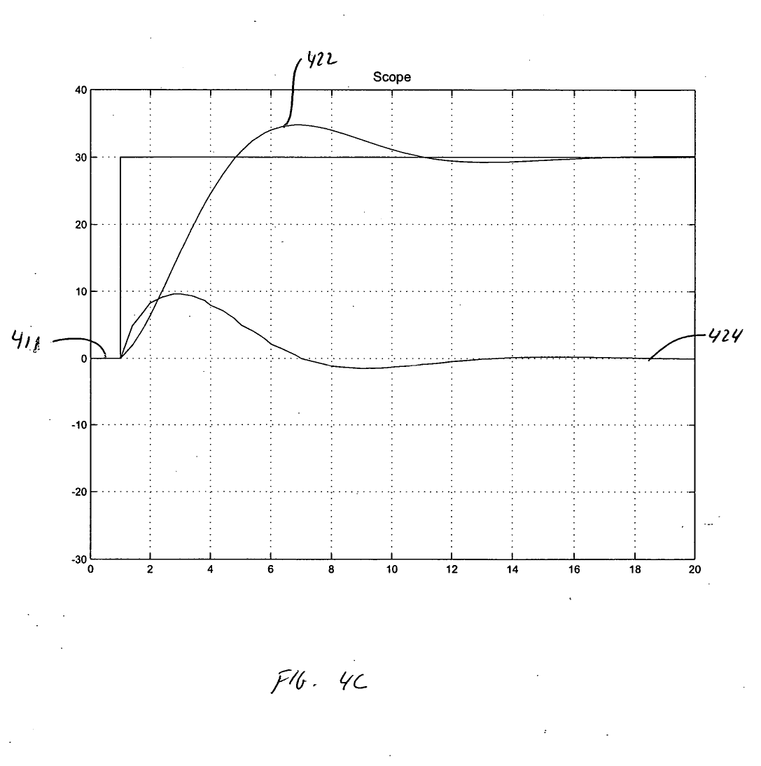

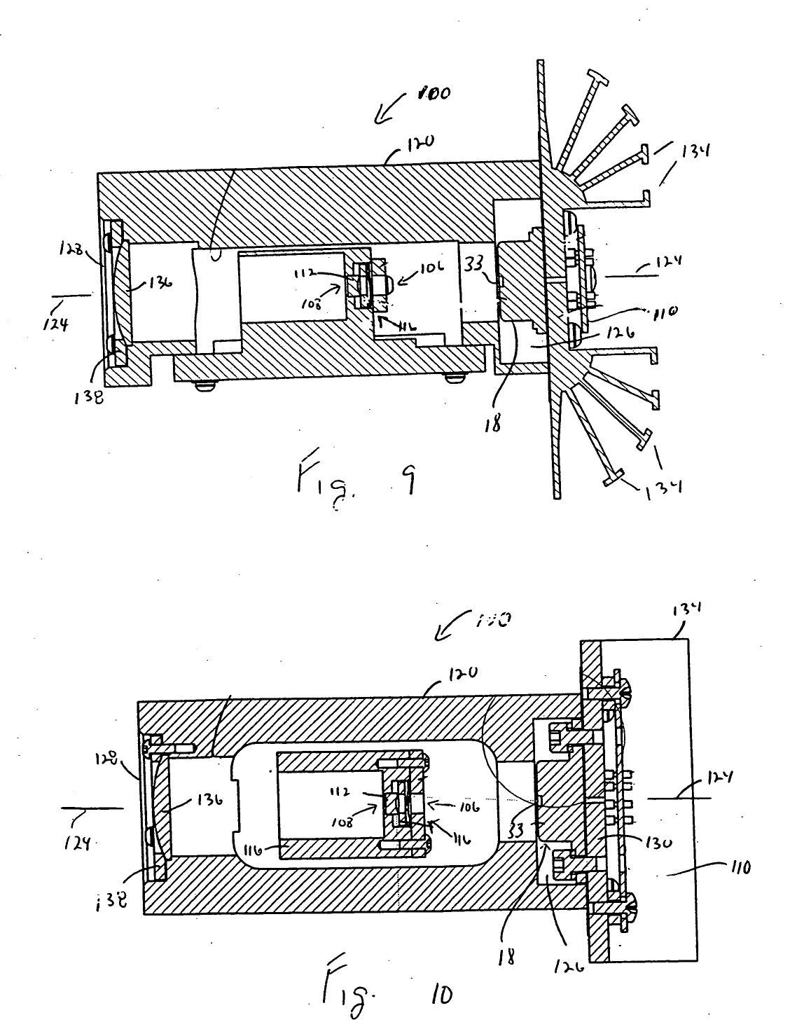

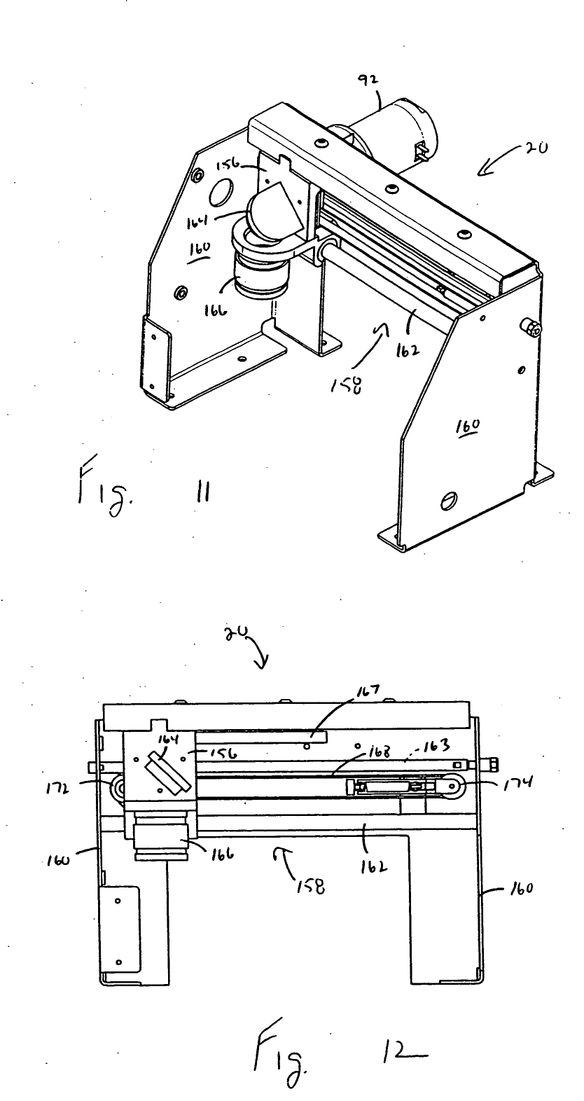

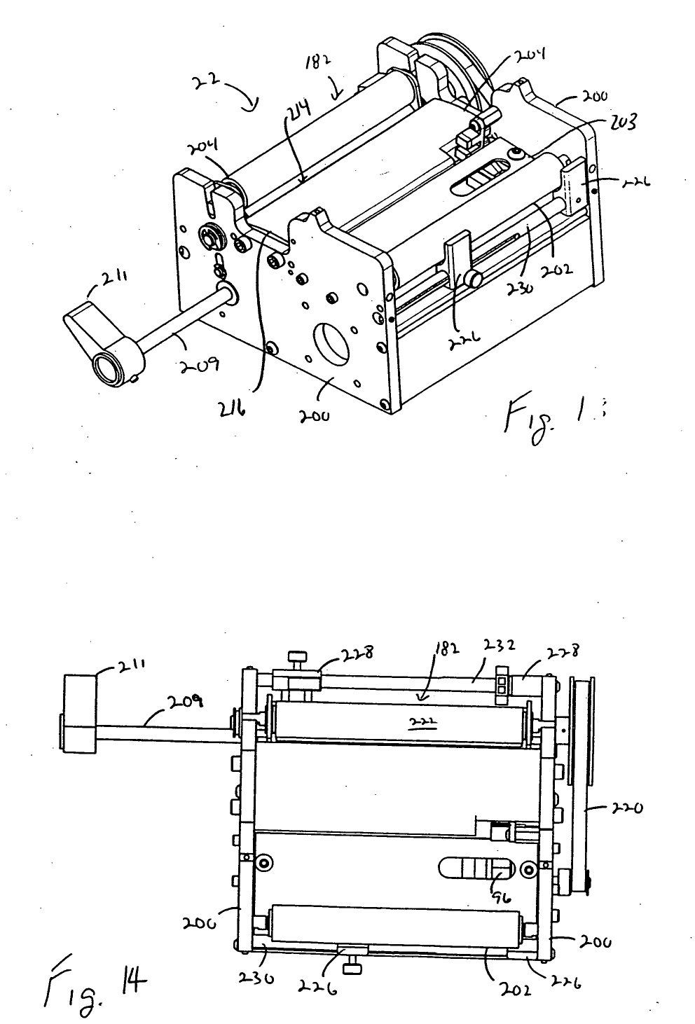

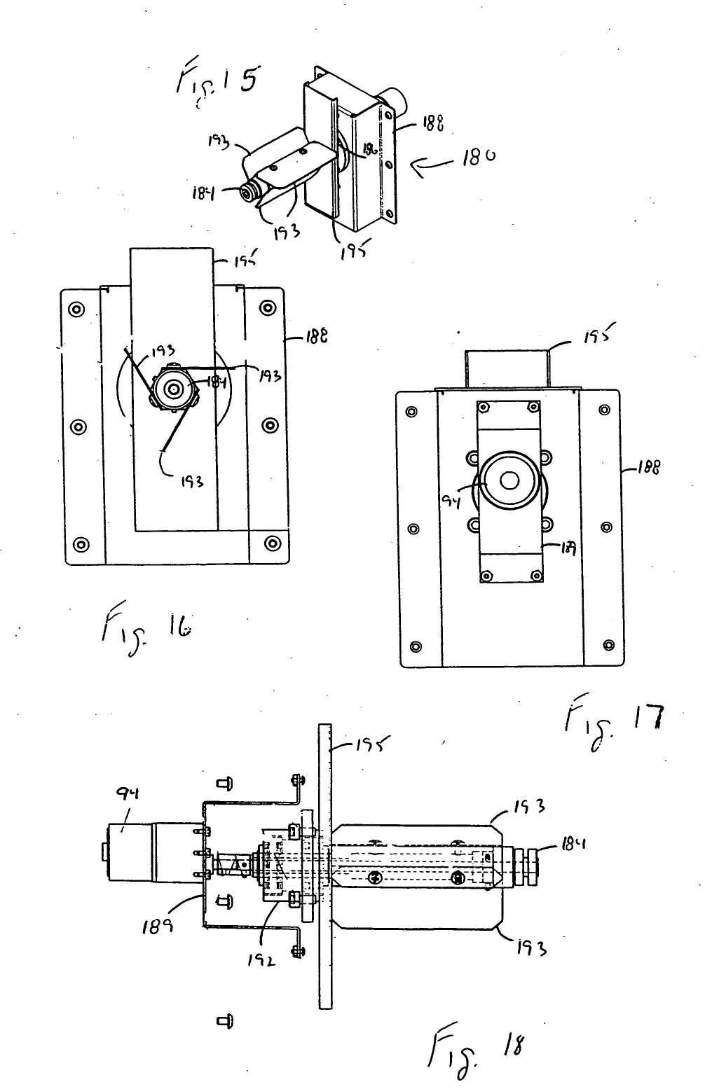

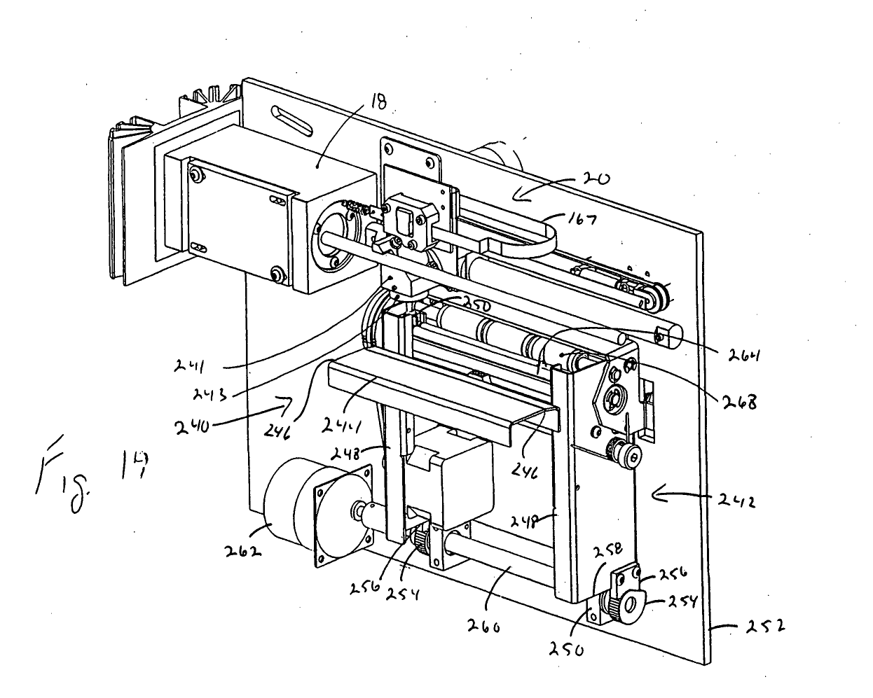

In the embodiment disclosed in FIGS. 7, 13-18, the media feed assembly 22 is adapted to feed the image receiving target media 24 in the form of a roll of label media 26 into the path of the light pulses to form an image thereon. The roll of label media 26 is supported by a media spool 180, and a continuous strip of label media 26 is pulled off of the roll by a media drive assembly 182 forming part of the media feed assembly 22. Of course, a media feed assembly adapted for other types of image receiving targets can be completely different from the media feed assembly disclosed herein. For example, a media feed assembly adapted for a circuit board being marked by the microlaser can consist of a fixed platform which supports the circuit board in the path of the light pulses, and the circuit board is placed on the platform manually or using automated manipulators. Moreover, the media feed assembly can be any conveying mechanism which can position an object in the path of the light pulses, such as conveyors, and the like, without departing from the scope of the invention.

The media spool 180 is disposed rearwardly of the printing enclosure 14 (FIG. 5), and includes a spool shaft 184 supported at one end 186 by a bracket 188 fixed to the electrical enclosure right side wall 34. The spool shaft 184 supports the roll of label media 26, and is rotatably driven by a back feed motor 94 electrically connected to the control circuitry 56 (shown in FIG. 3). The back feed motor 94 is preferably coupled to the spool shaft 184 by a slip clutch 192. A motor mount bracket 189 fixes the back feed motor 94 to the electronic enclosure right side wall 34 relative to the spool shaft 184. Fins 193 extending tangentially from the spool shaft 184 engage the inside surface of the label media roll 26 to prevent the roll from slipping relative to the spool shaft 184. A back stop 195 fixed relative to the bracket 188 registers the roll of label media 26 on the media spool 180.

The back feed motor 94 reverse winds the label media 26 onto the roll to back feed (i.e. pull the label media 26 in reverse along the media path) to position an overfed label in the path of the light pulses for receiving an image. Advantageously, the back feed motor 94 and slip clutch 192 resist forward rotation (i.e. rotation of the spool which unwinds label media 26 therefrom) of the media spool shaft 184 to maintain tension in the label media 26 as it unwinds from the roll. Although tensioning the label media 26 using the back feed motor 94 and slip clutch 192 is disclosed, any friction or tension device known in the art, such as a clip which induces drag on the spool, a tensioning idler roller, and the like, can be used to maintain tension in the label media without departing from the scope of the invention.

The media drive assembly 182 is disposed in the printing enclosure 14 beneath the light guidance system 20, and pulls the label media 26 from the media spool 180. The media drive assembly 182 includes end frames 200 that support an inlet guide roller 202, a platen 204, a nip roller 206, and a drive roller 208 therebetween. The inlet guide roller 202 guides the label media 26 along the media path over the platen 204 which supports the label media 26 in the path of the light pulses as the label media 26 is pulled over the platen 204 by the drive roller 208.

The inlet guide roller 202 extends between the end frames 200 transverse to the media path inside the printing enclosure 14 adjacent to an inlet slot 210 formed in the rear wall 150 of the printing enclosure 14. The label media 26 passes through the slot 210, and engages the guide roller 202 which guides the label media 26 over the platen 204. Preferably, the guide roller 202 has a low friction radially outwardly facing surface 203, such as stainless steel, which engages the label media 26 as it is pulled along the media path. Although a nonrotating inlet guide roller is shown, a freely rotating or driven guide roller can be provided without departing from the scope of the invention. Advantageously, the inlet guide roller 202 guides the label media 26 over the platen 204 which supports the label media 26 as an image is formed thereon by the light pulses.

The platen 204 extends between the end frames 200 downstream of the guide roller 202, and includes a convex upper surface 214 having a substantially flat crown 216 facing the focusing lens 166. The crown 216 engages the tensioned label media 26 to present a wrinkle free substantially flat label media for receiving an image. Although a crowned platen 204 is preferred in this embodiment, platens having other shapes that engage the label media, such as flat, round, polygonal, and the like, can be used without departing from the scope of the invention.

The drive roller 208 and a nip roller 206 extend between the end frames 200 transversely across the media path downstream of the platen 204. The label media 26 is sandwiched between the drive and nip rollers 208, 206 which cooperatively pull the media off of the media roll and over the platen 204. Preferably, the nip roller 206, drive roller 208, and guide roller 202 urge the label media 26 below a substantially horizontal plane defined by the platen crown 216 to ensure the label media 26 is urged flat against the crown 216 to present a wrinkle free, substantially flat media target.

The drive roller 208 is rotatably driven by the stepper motor 96 through a synchronous belt 220, and includes an elastomeric radially outer surface 222 which engages the label media 26. The nip roller 206 is freely rotatable, and has a radially outer surface 224 that urges the label media 26 against the drive roller outer surface 222. Preferably, the nip roller outer surface 224 is formed from an elastomeric material to positively grip the label media 26.

The nip roller 206 is movable relative to the drive roller 208, such as by actuation of a cam (not shown) fixed to a manually rotatable shaft 209 which urges the nip roller 206 away from the drive roller 208 to form a space therebetween. The space simplifies threading the label media 26 between the nip and drive rollers 206, 208 when loading a new roll of label media 26 through the media drive assembly 182. A lever 211 on an end of the shaft 209 can be provided for manually rotating the shaft 209.

Edge guides 226, 228 upstream and downstream of the platen 204 along the media path engage the label media 26 and guide it along the media path. Preferably, the edge guides 226, 228 are supported by rods 230, 232 extending between the end frames 200, and at least one edge guide 226, 228 upstream and downstream of the platen 204 is adjustable by the operator to size the transverse width of the media path for a particular label media width. The upstream guides 226 guide the label media 26 over the platen 204, and the downstream guides 228 guide the printed label media 26 through an exit slot 234 formed in the printing enclosure 14.

Outlet guides 236 extend upstream along the media path from the exit slot 234 toward the nip and drive rollers 206, 208. Preferably, the outlet guides 236 are strips of material, such as lips formed part of the printer enclosure 14. The outlet guide 236 guides the label media 26 through the exit slot 234 to prevent label media jams. Although a pair of solid outlet guides 236 extending the entire width of the exit slot 234 is shown, one or more fingers extending inwardly from the exit slot can be provided to guide the label media without departing from the scope of the invention.

Referring to FIGS. 1-18, in use, an operator can download images via the electrical interfaces 70, 72, 74, or manually enter images, such as text and indicia, via the user interfaces 64, 66, 42, into the control circuitry 56. The control circuitry 56 controls the microlaser package 18 to selectively generate light pulses, controls the carriage motor 92 to move the carriage 156 and guide the light pulses, and controls the drive roller stepper motor 96 to advance the label media 26 to form the desired image on the label media 26, as described above. When light pulses are not desired during the creation of the image, such as while the label media 26 is being advanced along the media path, the control circuitry 56 maintains the microlaser package 18 in the simmer mode to minimize the turn-on delay when light pulses are desired.

Once the image is formed on the label media 26, the drive roller stepper motor 96 advances the label media 26 through the printer enclosure exit slot 234. The printed label can be separated from the remaining label media 26 by a cutting mechanism, tearing, and the like, without departing from the scope of the invention. If the next printable label on the label media 26 is advanced past the platen 204, the control circuitry 56 engages the slip clutch 192 and energizes the back feed motor 94 to reverse wind the label media 26 on the media spool 180 and position the next printable label over the platen 204.

### Second Embodiment

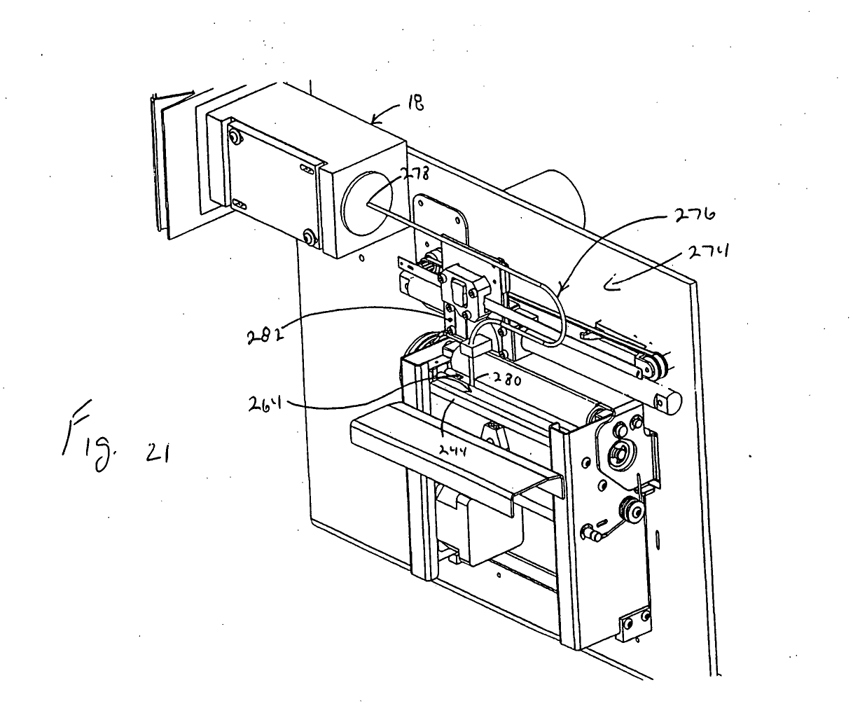

In an embodiment disclosed in FIGS. 19 and 20, the mark position system 17 (FIG. 1) comprises a media feed assembly 240, including a vertically adjustable lazing platform 242 which can be adjusted to vary the dot size formed on the label media 26 disposed beneath a light guidance assembly 20, such as disclosed above, having a mirror 241 and focusing lens 243. The lazing platform 242 includes a platen 244 supported at opposing ends 246 by vertically slidable C-shaped frame members 248. Each frame member 248 wraps around a guide rail 250 fixed to a printer enclosure rear wall 252.

The frame members 248 are urged vertically by cams 254 engaging a camming member 256 fixed to a lower end 258 of each frame member 248. Each cam 254 is fixed to a rotatable shaft 260 extending transversely beneath each frame member 248. A motor 262 coupled to the shaft 260 rotatably drives the shaft 260, and thus the cams 254, to vertically move the lazing platform 242. The motor 262 is controlled by the control circuitry 56 (FIG. 3) to precisely position the platen 244 relative to the focal length of the focusing lens 166 (FIG. 7) forming part of the light guidance assembly 20 to form a desired dot size on the label media 26.

A pair of hold down rollers 264 extend transversely to the media path across the platen 244, and urge the label media 26 against the platen 244 to provide a relatively flat surface in the label media 26 for receiving the image. Light pulses generated by the microlaser package 18 are directed between the hold down rollers 264 to form the image on the label media 26. Although hold down rollers 264 are disclosed to provide a relatively flat surface in the label media for receiving the image, the image receiving target can be secured against the platen, or other platform, using other methods, such as the method disclosed in the first embodiment, sandwiching the image receiving target between the platen and a transparent material, such as glass which allows the light pulses to pass therethrough, and the like, without departing from the scope of the invention.

In the media feed assembly 240 disclosed in FIGS. 19 and 20, the label media 26 is sandwiched between a nip roller 266 and a rotatably driven drive roller 268 disposed upstream of the platen 244 and hold down rollers 264. The nip and drive rollers 266, 268 cooperatively push the label media 26 past the platen 244 and hold down rollers 264. An idler roller 270 upstream of the drive and nip rollers 268, 266 guides the label media 26 into the printer enclosure slot 272 and between the drive and nip rollers 268, 266.

### Third Embodiment

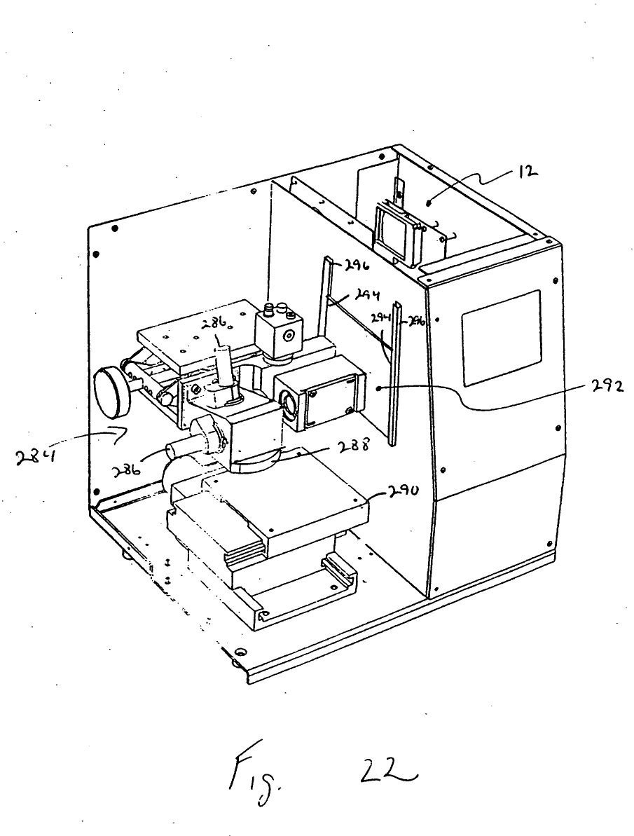

In another embodiment disclosed in FIG. 21, the mark positioning system 17 (FIG. 1) comprises a light guidance mechanism 274 and media feed assemblies, such as disclosed herein, which include an optic fiber 276. The optic fiber 276 has one end 278 coupled with the microlaser 33 to receive the light pulses and an opposed end 280 which emits the light pulses. The opposed end 280 is fixed to a carriage 282 which is transversely movable, such as described above in the first embodiment, and directs the high energy light pulses downwardly toward label media supported by the platen 244 between the pair of hold down rollers 264, as described above. The image can be formed on an image receiving target media 24 (FIG. 7), such as described above, which is fixed to a movable platen or stretched across a platen without departing from the scope of the invention.

### Fourth Embodiment

In yet another embodiment disclosed in FIG. 22, the mark positioning system 17 (FIG. 1) comprises a light guidance assembly 284, including a pair of pivotally mounted galvo mirrors 286 and the media positioning assembly 22 (FIG. 11) comprises a platform 290, which can be moveable with two degrees of freedom as described below. The galvo mirrors 286 guide the high energy light pulses through a focusing lens 288 toward an image receiving target. The control circuitry 56 (FIG. 3) pivots the mirrors 286 to guide the light pulses through the focusing lens 288 in a desired two-dimensional pattern to form an image on the image receiving target supported by a platform 290.

The focusing lens disclosed in FIG. 22 has a focal point which is a fixed distance from the lens 288. The light guidance assembly 284 and collimator assembly 100 (FIG. 8) are vertically movable relative to the platform 290 to change the distance between the lens 288 and the image receiving target to form different sized dots on the target. In particular, the collimator assembly 100 and guidance assembly 284 are cantilevered from a support plate 292 which is vertically movable to vary the distance between the focusing lens 288 and the platform 290. Preferably, the support plate 292 has edges 294 slidably received in rails 296 fixed to a wall of the electronic enclosure 12. Referring now also to FIG. 3, the plate 292 is vertically movable using a stepper motor 91 controlled by the controlled circuitry 56 to change the distance between the focusing lens 288 and the image receiving target media 24 (FIG. 7) supported on the platform 290.

In the embodiment disclosed in FIG. 22, the platform 290 has two degrees of freedom which allows an image to be formed on portions of the target media 24 which are beyond the operable range of the galvo mirrors 286 if the platform was fixed. Of course, the image receiving target can be conveyed through the light pulse path, such as described in the above embodiments, or fixed to a fixed platform, without departing from the scope of the invention.

### Alternate Embodiments

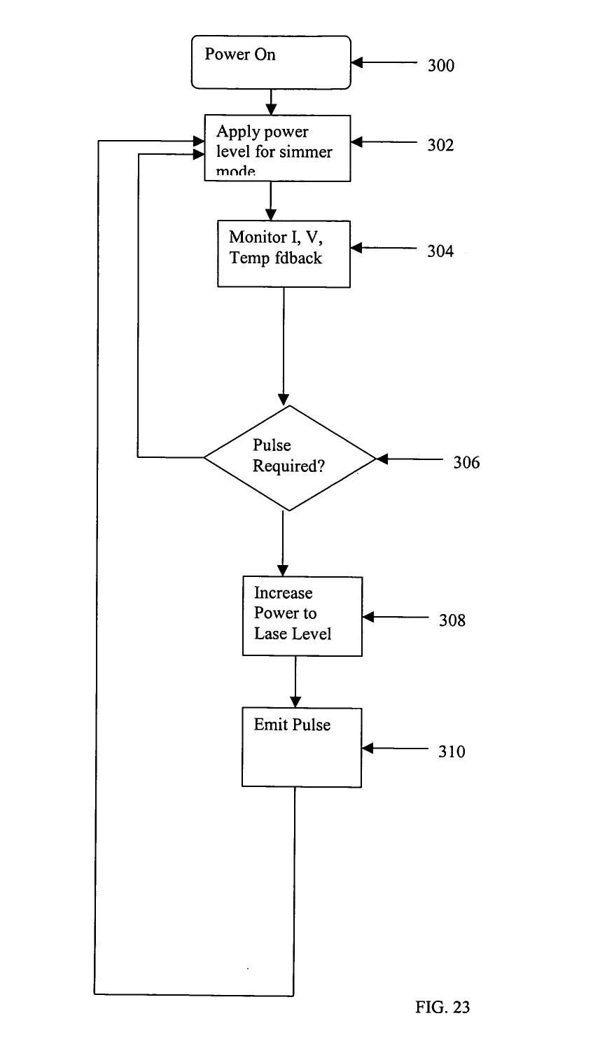

Although the simmer mode of operation has been described above specifically with reference to a printing or marking application, the simmer mode operational technique can be applied and used in conjunction with microlasers in various applications, as, for example, in medical and military applications. Here, it is frequently beneficial to be able to produce high energy pulses of light within a reasonably short time frame. Referring now to FIG. 23, the general steps for operation of a simmer mode are shown. As described above, after the circuitry associated with a microlaser is powered on (step 300), a power level selected to maintain the microlaser below the threshold saturation absorbed power level is applied to the microlaser to maintain the microlaser in the “simmer mode” (step 302). The current, voltage, and temperature of the microlaser are monitored (step 304) to maintain the microlaser at a level below the saturation absorbed power threshold until a pulse is required. When it is determined that a pulse is required (step 306), the level of power applied to the microlaser is increased (step 308), driving the microlaser to emit one or more pulse of light (step 310). These steps can be associated with control circuitry for controlling a number of different laser operations, and the speed between emitted pulses increased, as described particularly with reference to FIG. 2A above.

While there has been shown and described what are at present considered the preferred embodiments of the invention, it will be obvious to those skilled in the art that various changes and modifications can be made therein without departing from the scope of the invention defined by the appended claims.

We claim:

1. A method for marking a target media using a microlaser which upon reaching an absorbed power saturation threshold emits a high peak power pulse of light, said method comprising:
driving the microlaser at a simmer power level selected to maintain the microlaser below the saturation threshold and to limit the activation time of the microlaser;
directing the microlaser at the target media on which the mark is to be made;
increasing the power applied to the microlaser to the saturation threshold to cause the microlaser to emit a pulse of light for forming the mark; and
decreasing the power applied to the microlaser to the simmer level after the mark is formed.

2. The method of claim 1, including directing said pulse of light emitted by said saturable absorber along a path toward the target media.

3. The method of claim 1, including directing said pulse of light with at least one mirror.

4. The method of claim 3, in which said at least one mirror is pivotally mounted, and directing said pulse of light includes pivoting said mirror.

5. The method of claim 1, including directing said pulse of light through a fiber optic material.

6. The method of claim 2, including feeding said target media into the path of said pulse of light.

7. The method of claim 1, in which said predetermined level below the saturation threshold is at least 50% of the saturation threshold.

8. The method of operating a laser marking/imaging system as in claim 1, in which said predetermined level below the saturation threshold is at least 90% of the saturation threshold.

9. The method of claim 1, wherein the microlaser is a passively Q-switched laser.

10. A laser marking/imaging system comprising:
a passively Q-switched microlaser having a saturable absorber which upon reaching a saturation power threshold emits a pulse of light through an optical output;
control circuitry electrically connected to said microlaser to maintain the microlaser in a simmer mode below said saturation power threshold when not providing a mark, and for driving the microlaser to the saturation power threshold to emit a pulse of light when a mark is required; and
a guidance mechanism which directs said pulse of light from said optical output along a path toward an image receiving target when said control circuit is in said lasing mode.

11. The laser marking/imaging system as in claim 10, in which said guidance mechanism includes a flexible fiber optic material having an input end which receives said pulse of light from said optical output and an output end through which said pulse of light exits said fiber optic material.

12. The laser marking/imaging system as in claim 11, in which said output end of said fiber optic material is mounted to a movable carriage disposed adjacent said image receiving target.

13. The laser marking/imaging system as in claim 10, in which said guidance system includes at least one mirror which directs said pulse of light from said optical output.

14. The laser marking/imaging system as in claim 13, in which said at least one mirror is pivotally mounted.

15. The laser marking/imaging system as in claim 10, including a media feed assembly feeding an image receiving target into the path of said pulse of light.

16. The laser marking/imaging system as in claim 15, in which said media feed assembly includes a platen supporting the image receiving target in the path of said pulse of light.

17. The laser marking/imaging system as in claim 16, in which at least one of said platen and at least a portion of said guidance system is movable to vary the distance between said platen and said at least a portion of said guidance distance.

18. The laser marking/imaging system as in claim 10, in which said guidance system includes a carriage movable relative to said optical output, and said carriage supports structure which directs said pulse of light toward the image receiving target.

19. The laser marking/imaging system as in claim 10, including a platform disposed in the path of said light pulse for supporting the image receiving target in the path of said light pulse.

20. The laser marking/imaging system as in claim 19, in which said platform includes at least one degree of freedom.

21. The laser marking/imaging system as in claim 10, in which said control circuitry is disposed in an electrical enclosure and said guidance mechanism is disposed in a printing enclosure separated from said electrical enclosure.

22. The laser marking/imaging system as in claim 21, in which said electrical enclosure and said printing enclosure are separated by a common wall.

23. The laser/imaging system as in claim 10, in which power provided to said microlaser is maintained at a power level of at least 50% of said power threshold in said simmer mode.

24. The laser/imaging system as in claim 10, in which power provided to said microlaser is maintained at a power level of at least 90% of said power threshold in said simmer mode.

25. The laser/imaging system as in claim 10, wherein said control circuitry is further connected to a cooling system to drive the cooling system and to a temperature sensor to monitor an actual temperature and wherein the control circuit further comprises a controller for driving the cooling system.

26. The laser imaging system as in claim 25, wherein the controller employs a proportional-integral-differential loop to drive the microlaser.

27. The laser imaging system as in claim 25, further comprising a photodiode electrically coupled to the microlaser and to the controller, the photodiode providing feedback when the microlaser is activated wherein the controller monitors the repetition rate of the microlaser.

28. A method for operating a microlaser having a saturable absorbed power threshold, the method comprising the following steps:
applying power to the microlaser at a simmer level selected to maintain the laser below the absorbed power threshold;
determining when a pulse is required; and
increasing the power applied to the microlaser to a level above the absorbed power threshold, wherein the microlaser emits a pulse.

29. The method as defined in claim 28, further comprising the step of monitoring a temperature level of the microlaser to maintain the microlaser within a selected operational temperature range.

30. The method as defined in claim 29, further comprising the step of employing a proportional-integral-derivative loop to maintain a temperature of the microlaser within a predetermined range.

31. The method as defined in claim 28, further comprising the steps of activating a photodiode whenever the microlaser is actuated and monitoring the photodiode to determine a repetition rate of the microlaser.
